(19) United States
(12) Patent Application Publication
(10) Pub. No.: US 2007/0065179 A1
(43) Pub. Date: Mar. 22, 2007

(54) Image forming apparatus having a charging brush capable of effectively removing contaminants including residual fine toner

(76) Inventor: Tetsumaru Fujita, Nishinomiya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/522,458

(22) Filed: Sep. 18, 2006

(30) Foreign Application Priority Data
Sep. 16, 2005 (JP) 2005-270244
May 19, 2006 (JP) 2006-140529

(51) Int. Cl. G03G 15/02

(52) U.S. Cl. 399/175

(57) ABSTRACT

An image forming apparatus may include a photoreceptor, a cleaner and a charging mechanism. The cleaner may have a blade-like shape and may remove contaminants including residual toner from the photoreceptor. The charging mechanism may include a charging brush which may have a pile length not greater than 3 mm and a pile density of not smaller than 200,000 piles/6.45 sq. cm and may rotate in a direction counter to a rotation direction of the photoreceptor while contacting the photoreceptor.

### CROSS REFERENCE TO RELATED APPLICATIONS

This patent specification is based on Japanese patent application No. JP2005-270244 filed on Sep. 16, 2005 and No. JP2006-140529 filed on May 19, 2006 in the Japan Patent Office, the entire contents of which are incorporated herein by reference.

### BACKGROUND

1. Field of Invention

Exemplary aspects of the present invention relate to an image forming apparatus, and more particularly to an image forming apparatus which includes a brush-type charging mechanism for electrically charging a device including a photoreceptor mounted in image forming apparatuses, for example, a copier, facsimile, printer and the like, and a process cartridge including the charging apparatus to effectively remove contaminants including residual fine toner.

2. Discussion of the Background

Generally, in image forming apparatuses such as copiers, printers, facsimiles, or the like using an electrophotographic process, an image carrier surface is charged and exposed so as to form an electrostatic latent image. The electrostatic latent image is then developed using color toner so that a toner image is formed as a visible image. Subsequently, the toner image is transferred onto a transfer object such as transfer paper, and is fixed by a heating roller or the like to form an image. Generally, after the toner image is transferred, toner residue which has not been transferred remains on the image carrier surface. Consequently, the toner residue needs to be removed by a cleaning mechanism before a subsequent image forming processing takes place.

Furthermore, a substance other than the residual toner adhered on the image carrier surface is generally removed together with the residual toner by the cleaning mechanism. There are various types of cleaning mechanisms for removing toner residue after the transfer process, such as a fur brush, a magnetic brush, a cleaning blade made from an elastic body or any other suitable material. The cleaning mechanism using the cleaning blade which sweeps the image carrier to remove the residual toner is commonly used, because it is economical and stable in its performance.

Recently, with the realization of a higher image quality in a color image forming apparatus, down-sizing and conglobation of toner particles are pursued, according to, for example, Japanese Patent Laid-Open Application Publications, No. JP2004-117438. By downsizing the toner particles, reproducibility of dots of the toner image formed on the image carrier surface is enhanced, while the conglobation of the toner particles enhances the developmentability and transferability. However, in the cleaning apparatus using a related art cleaning blade, when using toner particles having a small diameter or a spherical shape, it may be difficult to thoroughly remove the residual toner on the image carrier surface after transfer processing. Consequently, cleaning problems may be generated.

The cleaning problems may be generated due to following reasons when using toner particles of a small diameter or spherical toner. In a cleaning method using a cleaning blade, a rubber blade as described above, slidably sweeps the image carrier so as to scrape off the toner. Consequently, due to friction resistance between the image carrier and the rubber blade, a shape of a tip edge of the rubber blade may be deformed forming a small wedge space therebetween. When the diameter of the toner particles is small, the toner may easily slip by the tip edge. The toner slipped into the tip edge may not easily be moved, thereby forming an illiquid region.

The spherical toner may closely be packed when compared with irregular-shape toner. Therefore, the spherical toner may easily be consolidated into a tiny space adjacent to a contact area where the edge of the cleaning blade comes into contact with an image carrier. In a state where the friction resistance between the toner in the illiquid region and the image carrier is relatively small, and the toner slips relative to the image carrier, the cleaning problems may not occur. However, when an exterior additive is separated due to friction with the image carrier causing the frictional force between the toner and the image carrier to increase, the spherical toner may start to migrate between the cleaning blade and the image carrier. This is because the migration friction of the spherical toner is small, when compared with a related art irregular-shape toner produced by a pulverization method. Thus, the spherical toner slips through the cleaning blade.

FIG. 1 illustrates an example of a related art image forming apparatus to which exemplary embodiments of the present invention may be applied. With reference to FIG. 1, a reference numeral 1 designates a photoreceptor; 2 designates a charging unit as a charging mechanism; 3 designates an optical beam; 4 designates a developing unit as a developing mechanism; 5 designates a transfer roller; 6 designates a fixing unit; 7 designates a cleaning device as a cleaning mechanism; 10 designates a recording sheet conveying path; and 11 designates transfer toner residue, respectively. For the sake of clarity, the toner residue 11 is exaggeratedly indicated.

The toner, which causes the cleaning problems as described above, slips through forming streaks. Thus, at a time of image forming subjected to a subsequent output, an image quality is decreased by having the streaks. Especially in a case where the charging unit 2 is a contact charging roller as shown in FIG. 1, the toner in a form of a streak, which is not completely removed or is not cleaned by the cleaning blade or the like, may be accumulated in a pattern of streaks in the contact charger such as the charging roller. Thereby, charging problems are generated. Furthermore, an image with streaks is generated when the charging problem is induced as a pattern of streaks in the charging unit; an exposure problem also occurs in the pattern of streaks in an exposure unit; and/or the streak-shaped toner is transferred without being recovered during development.

A cleaning capability is significantly deteriorated, if a later-described circularity of the toner is closer to 1, that is, closer to a spherical shape or complete spherical. Even if the circularity of the toner is less than 0.95, the toner has a shape distribution. Thus, toner having particles of almost spherical shape exists. Accordingly, the cleaning capability tends to also be deteriorated over time.

In order to effectively remove toner residue remained on an image carrier in an image forming apparatus using spherical toner, Japanese Patent Laid-Open Application Publication No. JP2001-228682 proposes a cleaning apparatus which includes a cleaning blade to scrape off toner residue from a photoreceptor surface after transfer, and a cleaning brush disposed on a further upstream side than that of the cleaning blade in a moving direction of the photoreceptor to pulverize the toner residue so as to generate fine-grain toner on the photoreceptor. However, in order to provide the cleaning brush for pulverizing the toner residue to generate the fine-grain toner on the photoreceptor, the size of the cleaning apparatus may increase. Furthermore, it may be very difficult to pulverize toner made of resin. Even if the toner is pulverized, a damage to the image carrier surface may be generated, thereby deteriorating the image quality.

In order to remove the toner, the related art image forming apparatus having a structure as shown in FIG. 1 may have an excess linear pressure setting. Consequently, there may be a problem in which the photoreceptor surface is excessively worn out and/or the blade itself is worn out so that it is difficult to attain a photoreceptor having high endurance and a long product life. Furthermore, with the conglobation of the toner and a reduction of the toner diameter, the circularity may be increased, and the particle diameter may be reduced. Accordingly, the toner may easily slip through the toner removal mechanism. Consequently, toner removal may become difficult, thereby forcing the linear pressure to be set to high. The above-described problem may be solved by using the image forming apparatus according to the exemplary embodiments of the present invention described below.

### SUMMARY OF THE INVENTION

In view of the foregoing, an exemplary embodiment of the present invention provides a novel image forming apparatus which includes a charging brush which effectively disperses a toner residue in a form of a streak slipped through a cleaning blade.

To achieve the above and other objects, in one example, an image forming apparatus may include a photoreceptor, a cleaner and a charging mechanism. The cleaner may have a blade-like shape and may remove contaminants including residual toner from the photoreceptor. The charging mechanism may include a charging brush which may have a pile length not greater than 3 mm and a pile density of not smaller than 200,000 piles/6.45 sq. cm and may rotate in a direction counter to a rotation direction of the photoreceptor while contacting the photoreceptor.

In one exemplary embodiment of the above-mentioned image forming apparatus, the charging brush of the charging mechanism may satisfy a relationship of 0.4>ρ/L>0.05, where ρ is a contact depth of the charging brush relative to the photoreceptor and L is the pile length.

The above-mentioned image forming apparatus may further include a development mechanism and a process cartridge. The development mechanism may develop an image with a fine toner, i.e. a toner having particles with a diameter between 3 and 9 μm. The process cartridge may be attachable and detachable relative to the image forming apparatus and may integrally support the photoreceptor and at least one of the charging mechanism, the cleaning mechanism and the development mechanism.

To achieve the above and other objects, in one example, an image forming apparatus using a toner may include a photoreceptor, a cleaner and a charging mechanism. The cleaner may have a blade-like shape and may remove contaminants including a fine toner (, i.e. a toner having particles with a diameter between 3 and 9 μm) from the photoreceptor. The charging mechanism may include a charging brush which has a pile length of not greater than 3 mm and a pile density of not smaller than 200,000 piles/6.45 sq. cm and may be rotated in contact with the photoreceptor in a same direction as a rotation direction of the photoreceptor such that a peripheral velocity ratio of the charging brush to the photoreceptor is greater than or equal to 2.

In one exemplary embodiment of the above-mentioned image forming apparatus, the charging brush of the charging mechanism may satisfy a relationship of 0.5>ρ/L>0.06, where ρ is a contact depth of the charging brush relative to the photoreceptor, and L is the pile length.

To achieve the above and other objects, in one example, a process cartridge for use in an image forming apparatus using a toner may include a photoreceptor and a mechanism that includes a development mechanism, a cleaning mechanism and a charging mechanism. The development mechanism may develop an image formed on the photoreceptor with a fine toner, i.e. a toner having particles with a diameter between 3 and 9 ρm. The cleaning mechanism may have a blade-like shape and may remove contaminants including residual toner from the photoreceptor. The charging mechanism may include a charging brush which may have a pile length not greater than 3 mm and a pile density of not smaller than 200,000 piles/6.45 sq. cm and may be rotated in a direction counter to a rotation direction of the photoreceptor while contacting the photoreceptor.

### BRIEF DESCRIPTION OF THE DRAWINGS

A more complete appreciation of the disclosure and many of the attendant advantages thereof will be readily obtained as the same becomes better understood by reference to the following detailed description of exemplary embodiments when considered in connection with the accompanying drawings, wherein:

FIG. 1 is a schematic diagram of a related art image forming apparatus;

FIG. 2 is a schematic diagram of an image forming apparatus according to an exemplary embodiment of the present invention; and

FIGS. 3 and 4 are schematic diagrams of different image forming apparatuses according to other exemplary embodiments of the present invention.

### DETAILED DESCRIPTION OF EXEMPLARY EMBODIMENTS

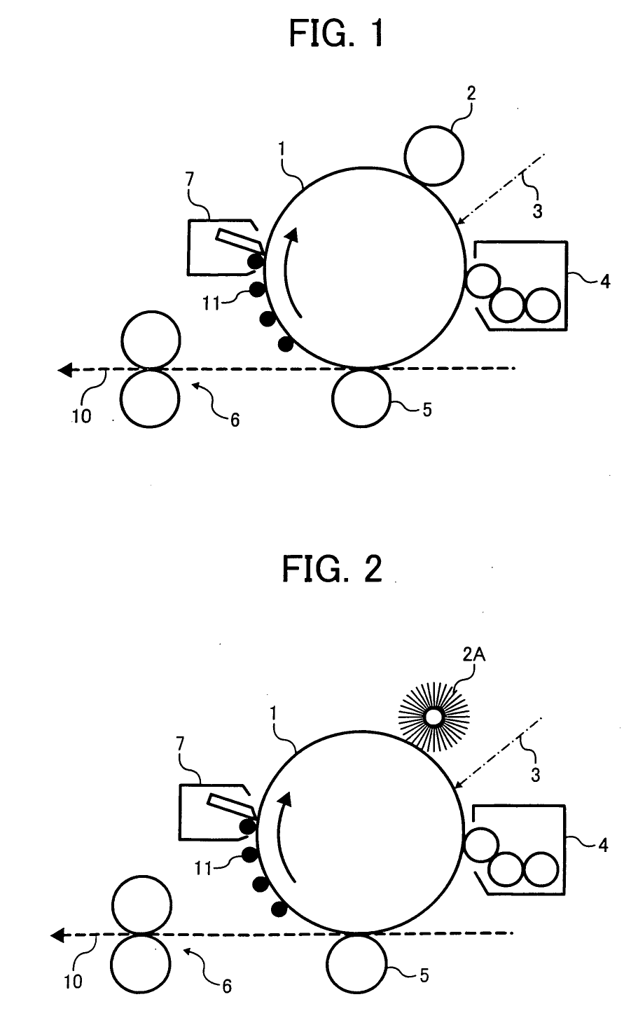

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. For the sake of simplicity of drawings and descriptions, the same reference numerals are given to materials and constituent parts having the same functions, and descriptions thereof will be omitted unless otherwise stated. Exemplary embodiments of the present invention are now explained below with reference to the accompanying drawings. Referring now to the drawings, wherein like reference numerals designate identical or corresponding parts throughout the several views, particularly to FIG. 2, exemplary embodiments of the present invention will be explained.

FIG. 2 illustrates a structure of an image forming apparatus or a laser printer of the present invention. The structure thereof is similar to that of the image forming apparatus shown in FIG. 1, except for a toner dispersing charging brush 2A. With reference to FIG. 2, a reference numeral 1 designates a photoreceptor; 2A designates a toner dispersing charging brush; 3 designates an optical beam; 4 designates a developing unit as a developing mechanism; 5 designates a transfer roller; 6 designates a fixing unit; 7 designates a cleaning device as a cleaning mechanism; 10 designates a recording sheet conveying path; and 11 designates transfer toner residue. For the sake of clarity, the toner residue 11 is exaggeratedly indicated.

In FIG. 2, the cleaning device 7 is equipped with a cleaning blade. On a downstream side thereof in a rotation direction of the photoreceptor drum, the toner dispersing charging brush 2A is disposed to disperse the toner which is not removed by the cleaning blade. The cleaning blade includes a toner removing function to remove the transfer toner residue 11 from the photoreceptor drum 1 and a polishing function to polish the surface of the photoreceptor drum 1. However, when using spherical toner and the like, the toner removing function may not be adequate enough to remove the toner so that toner may slip through the cleaning blade. Thus, a function to effectively disperse toner is added to a charging brush. The toner dispersing charging brush 2A is a charging brush having the supplementary function to effectively disperse toner.

The laser beam printer includes the photoreceptor drum 1, the toner dispersing charging brush 2A, a not-shown exposure unit, the developing unit 4, the transfer roller 5 and the cleaning device 7. The photoreceptor drum 1 serves as an image carrier on which a photosensitive layer is formed on a surface thereof and rotatively moves in an arrow direction as shown in FIG. 2. The toner dispersing charging brush 2A uniformly charges the photoreceptor drum 1 at a given potential. The not-shown exposure unit exposes the surface of the photoreceptor drum 1 by the optical beam 3 which is modulated in accordance with image information. The developing unit 4 develops, using the toner, the electrostatic latent image formed on the photoreceptor drum 1 by light exposure. The transfer roller 5 transfers the toner image developed on the photoreceptor drum 1 on a recording sheet. The cleaning device 7 cleans the surface of the photoreceptor drum 1 after the toner image is transferred. Surrounding the photoreceptor drum 1, the above-described devices are configured such that the devices sequentially carry out each of the processes including charging, exposure, development, transfer and cleaning, respectively. Accordingly, toner images to be transferred on the recording sheet are continuously formed.

In the exemplary embodiment of the present invention, a processing speed of the photoreceptor drum 1 is 100 mm/sec. A single component developer utilizing the toner is used in the developing unit 4. The electrostatic latent image on the photoreceptor drum 1 is developed by a non-contact developing method. A rotating speed of the developing roller, which rotates carrying the developer, is 1.5 times faster than a peripheral speed of the photoreceptor drum 1. In other words, the developing roller rotates at 150 mm/sec. A gap of 150 μm is provided between the photoreceptor drum 1 and the developing roller, and a developing bias voltage is applied therebetween so that an image area of the electrostatic latent image formed by the exposure is developed. As the developing bias voltage, the DC component on which the AC component is superimposed is used, while the DC component is −300V, and a square wave of the AC component has a peak-to-peak voltage (VPP) of 1.0 kV, a frequency of 2.0 kHz and a duty of 0.6. The charging unit 2 normally uses the charging roller to apply a DC bias of −1100 V so that the photoreceptor drum 1 is charged at a potential of −500V which is a potential of a background area, while an image area potential is −100V after exposure. The charging roller is made from ethylene propylene diene monomer (EPDM) with a shaft diameter of φ6 mm and an outer diameter of φ11 mm with a thickness 2.5 mm. A silicone layer is provided to a surface layer and has a resistance between 104 and 106 ohm. The charging roller is pressed against the photoreceptor by a spring so as to be rotatively driven.

The toner which has not been transferred remains on the image carrier surface after the toner image is transferred to a recording sheet or the intermediate transfer belt. Thus, the cleaning device 7 is provided on a downstream side of the transfer portion of the toner image. The cleaning device 7 is equipped with a cleaning blade which is made from a urethane rubber or any other suitable material with a thickness between 2 and 5 mm. The cleaning blade presses the tip edge thereof against the image carrier surface such that the toner is scraped and removed from the image carrier surface by the tip edge. The pressure force of the tip edge of the cleaning blade to the image carrier may easily be determined by adjusting a flexibility of the cleaning blade.

In the exemplary embodiments of the present invention, the pressure force is set to 40 N/m, and the pressure angle is 25 degree. The toner used in the exemplary embodiments is produced by an emulsion polymerization method and has a volume average particle diameter of 6.5 μm measured by a Coulter Counter manufactured by the Coulter Counter. The particle diameter does not have to be 6.5 μm, and may be between 3 and 9 μm. A toner having particles with an average diameter in the range between 3 and 9 μm is considered a fine toner. Inorganic microparticles such as silica particles of which average particle diameter is between 10 and 150 nm are added as an exterior additive as necessary. The charging amount of the toner is between −10 and −40 μC/g on the developing roller across from the photoreceptor drum 1. The charging polarity of the toner adhered to the photoreceptor drum 1 through development of the electrostatic latent image has a negative polarity. The toner may be produced by methods other than the emulsion polymerization method, such as a suspension polymerization method, dissolved suspension method, kneading pulverization method and so forth.

The shape of the particles of the toner is characterized using the concept of circularity. When considering an arbitrary projected particle image, A1 represents an area of the projected image, and L1 represents a circumference thereof. L2 represents a circumference of a circle having an area identical to that of the projected particle image A1. The circularity (S) is defined by a ratio (L2/L1). The circle may be characterized as a closed curve having the shortest circumference per area, and thus may be defined as L1≧L2, that is, 0≦S=L2/L1≦1. When the value of the circularity is closer to 1, the shape of toner becomes more spherical. When calculating the circularity (S), the calculation may be performed for a plurality of the toner particles, and the average value may be defined as a representative value.

In the exemplary embodiments of the present invention, spherical toner having the high circularity is used. As the shape of toner is close to spherical, a higher transfer rate may be attained when a toner image is transferred onto a recording sheet. Moreover, the amount of toner residue, which has not been transferred and thus needs to be removed from the photoreceptor drum 1 by the cleaning device 7, may be reduced. Accordingly, the size of a toner recovery bottle for recovering toner from the cleaning device 7 may be reduced so that downsizing of an inner space of the printer and cost reduction may be attained.

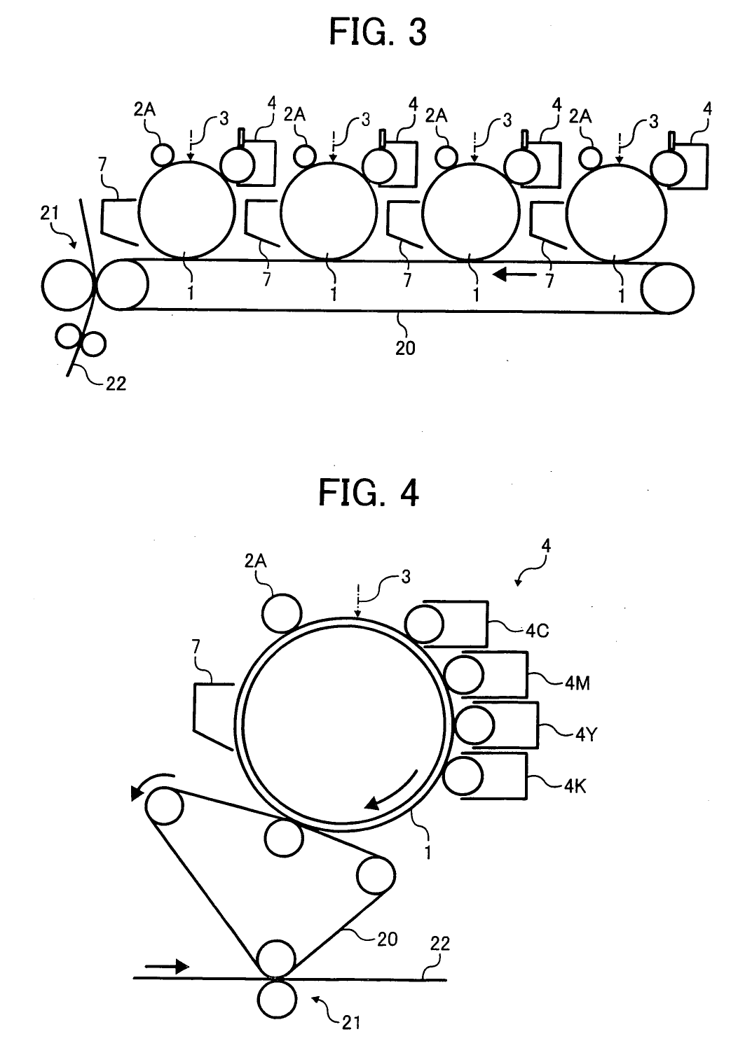

FIGS. 3 and 4 illustrate full-color image forming apparatuses using an intermediate transfer belt. In both FIGS. 3 and 4, a reference numeral 20 represents the intermediate transfer belt; 21 represents a transfer portion; and 22 represents a transfer sheet. The charging brush of the previous embodiment may be applied to the image forming apparatuses shown in FIGS. 3 and 4. The image forming apparatus of FIG. 3 is a tandem-type image forming apparatus configured such that a plurality of image forming units such as the ones shown in FIG. 2 (four units in FIG. 3) are disposed along the intermediate transfer belt 20. In the tandem-type color image forming apparatus, each of toner images of cyan (C), magenta (M), yellow (Y), and black (BK) formed on each of the photoreceptor drums 1 as an image forming unit is primarily transferred in sequence. Next, a secondary transfer takes place at the transfer portion 21 where the color toner image or the primary transfer image on the intermediate transfer belt 20 is transferred onto the transfer sheet 22.

On the other hand, in the color image forming apparatus of FIG. 4, there are four developing units 4C, 4M, 4Y and 4K which supply toner of each of colors cyan (C), magenta (M), yellow (Y) and black (BK) to a single photoreceptor drum 1. In the single-drum type full-color image forming apparatus, by switching operations of each of the developing units 4C, 4M, 4Y and 4K, toner images of each of the colors cyan (C), magenta (M), yellow (Y) and black (BK) are sequentially formed on the single photoreceptor drum 1. Subsequently, similarly to the above-described tandem-type image forming apparatus, the toner images of each of the colors cyan (C), magenta (M), yellow (Y) and black (BK) formed on the photoreceptor drum 1 are primarily transferred in sequence on the intermediate transfer belt 20. Next, the secondary transfer takes place at the transfer portion 21 where the color toner image or the primary transfer image on the intermediate transfer belt 20 is transferred onto the transfer sheet 22.

A description will be given of the toner dispersing charging brush 2A. When the transfer toner residue is not completely recovered by the cleaning blade, the remaining transfer toner residue may slip through the cleaning blade. The transfer toner residue is pressed and rubbed by the cleaning blade. Consequently, toner which originally has strong adhesion to the photoreceptor may slip through, and/or the shape of the toner may be changed so that the contact area thereof in which toner comes into contact with the photoreceptor drum may be increased. As a result, the adhesion to the photoreceptor may increase, and the toner with strong adhesion may be accumulated and slip through the cleaning blade in a pattern of streaks.

In a state where the toner is accumulated, the adhesion between toner increases. The toner in this state may intervene in discharging of and injection to the photoreceptor at the time when the photoreceptor drum is charged, thereby causing poor charging of the photoreceptor drum. At the time of exposure, the toner may interfere with the optical beam, thereby causing poor exposure of the photoreceptor drum. Furthermore, at the time of development, even in a potential condition where negative toner on the photoreceptor drum in a blank sheet area is recovered to the developing unit, the toner may be accumulated in the pattern of streaks and may have strong adhesion so that the toner may not be recovered to the developing unit. The toner is then transferred onto a recording sheet or onto the intermediate transfer belt, causing streaks in the image on the recording sheet. The similar phenomenon are confirmed in a case where a contact developing method is used.

Table 1 shows a result as to whether or not an image with unremoved streaks is generated, when toners with different circularity are used; a charging roller is mounted; and 5,000 prints are made with A4 paper. In Table 1, when unremoved streaks or uneven charging are observed, YES is indicated; whereas, when unremoved streaks or uneven charging are not observed, NO is indicated. Similarly to Table 1, in the later described tables, when a phenomena is observed, YES is indicated; whereas, when a phenomena is not observed, NO is indicated.

TABLE 1

| | UNREMOVED | UNEVEN |
|---|---|---|
| CIRCULARITY | STREAK | CHARGING |
| 0.95 | NO | NO |
| 0.96 | YES | NO |
| 0.99 | YES | NO |

When the circularity is greater or equal to 0.96, it is understood that unremoved streaks are generated. On the other hand, in a case where a charging brush having the dispersing mechanism is used and effectively disposed, the accumulated toner having strong adhesion and slipped through the cleaning blade in the pattern of streaks is dispersed so that the accumulated toner is once removed from the adhering position and moved. Thereby, the adhesion of the toner is reduced. Since each of the toner particles is separated, the discharging and injection at the time of charging of the photoreceptor or when the optical beam is used at the time of exposure are not affected. Even if the discharging and injection are affected, the amount of the intervention may be for one particle, and thus the image quality is not degraded. Furthermore, at the time of development, the toner is in a state where the adhesion to the photoreceptor drum decreases so that the toner is easily recovered during development. Accordingly, after the development, the toner does not remain on the photoreceptor, thereby producing a quality image.

In order to verify the effectiveness of the exemplary embodiments of the present invention, an experiment was performed to confirm toner dispersing capability and charging performance. Table 2 illustrates the result of the following experiment. In the experiment, the toner having circularity of 0.99 and charging brushes with different pile length (mm) and pile density (piles/sq. cm, where sq. cm is the square of cm) are used to make 5,000 prints with A4 paper. Each pile of the charging brushes has a pile thickness of 2 decitex. The charging brush is disposed in contact with the photoreceptor drum, and a contact depth is set to 0.5 mm. The contact depth is a penetration depth of the charging brush into the photoreceptor drum when assuming the photoreceptor surface is made of soft material. However, in this embodiment, the charging brush does not penetrate into the photoreceptor, and instead, the charging brush flexes against the photoreceptor drum. The charging brush is counter-rotated at 1 rpm with respect to the photoreceptor drum.

TABLE 2

| | | PILE | | |
|---|---|---|---|---|
| | PILE | DENSITY | | |
| | LENGTH | (piles/ | UNREMOVED | UNEVEN |
| MATERIAL | (mm) | 6.45 sq.cm) | STREAK | CHARGING |
| NYLON | 4 | 200,000 | YES | NO |
| | 3 | 200,000 | NO | NO |
| | 2 | 200,000 | NO | NO |
| | 3 | 100,000 | NO | YES |
| | 3 | 200,000 | NO | NO |
| | 3 | 300,000 | NO | NO |
| ACLYRIC | 4 | 200,000 | YES | NO |
| | 3 | 200,000 | NO | NO |
| | 2 | 200,000 | NO | NO |
| | 3 | 60,000 | NO | YES |
| | 2 | 60,000 | NO | YES |

It is confirmed according to the above-described experiment that when the charging brush having the pile length less than 3 mm and the pile density of greater or equal to 200,000 piles/6.45 sq. cm is used and counter-rotated, the toner is dispersed so that an image having streaks generated by the toner slipped through the cleaning mechanism is not formed. Also, it is confirmed that the toner is uniformly charged by the charging brush so that an irregular image is prevented. The charging brush may be made from nylon, acrylic, polypropylene or polyester. The charging performance is achieved when a resistivity is between 103 and 109 ohm. The thicker the pile thickness is, the higher the dispersion effect becomes. However, the dispersion effect may still be attained, when the pile thickness is less than 2 decitex.

According to the experiment results shown in Table 2, the toner is effectively dispersed, and an image without streaks is generated by the unremoved toner. If the charging brush is strenuously in contact with the photoreceptor drum, the brush pile strenuously scrapes the photoreceptor drum, causing the photoreceptor drum to have an irregular shape after a certain time. Consequently, the photoreceptor drum is unevenly polished. If the contact condition of the charging brush is reasonably adjusted, the photoreceptor drum is evenly polished, and a quality image may be attained during a long period of usage of the apparatus.

An experiment was performed to confirm the uneven polishing of the photoreceptor. Table 3 illustrates the results of the experiment in which the toner having the circularity of 0.99 and charging brushes made from nylon with different pile length and contact depth are used to make 20,000 prints with A4 paper. Each charging brush has a density of 200,000 piles/6.45 sq. cm and the pile thickness of 2 decitex, and is counter-rotated at 1 rpm relative to the photoreceptor.

TABLE 3

| | CONTACT | | UNREMOVED | UNEVEN |
|---|---|---|---|---|
| PILE LENGTH L | DEPTH ρ | ρ/L | STREAK | CHARGING |
| 3 | 0.1 | 0.03 | YES | NO |
| 3 | 1.2 | 0.40 | NO | NO |
| 3 | 1.4 | 0.47 | NO | YES |
| 2 | 0.1 | 0.05 | NO | NO |
| 2 | 0.8 | 0.40 | NO | NO |
| 2 | 1 | 0.50 | NO | YES |
| 0.8 | 0.05 | 0.06 | NO | NO |
| 0.8 | 0.3 | 0.38 | NO | NO |
| 0.8 | 0.4 | 0.50 | NO | YES |

According to the experiment results in Table 3, when 0.4>ρ/L>0.05, where L is the pile length and ρ is the brush contact depth, the toner dispersing effect is maintained, and the uneven polishing of the photoreceptor does not occur so that a quality of the image is achieved for a long period of usage of the photoreceptor. When rotating the charging brush in the same direction as that of the photoreceptor, the ability of dispersion of the slipping toner is decreased. However, if the peripheral velocity is increased, the toner having strong adhesion may strenuously be separated, and the similar toner dispersing effect as that of when the charging brush is counter-rotated may be achieved.

An experiment was performed to confirm the toner dispersing capability and the charging performance. Table 4 illustrates the results of the experiment in which the toner having the circularity of 0.99 and charging brushes with different pile length and pile density are used to make 5,000 prints with A4 paper. Each pile of the charging brushes has a pile thickness of 2 decitex, and a contact depth is set to 0.5 mm. Each charging brush is rotated relative to the photoreceptor in the same direction as that of the photoreceptor, and the peripheral velocity during rotation is varied.

According to the experiment results shown in Table 4, it is confirmed that when the peripheral velocity ratio θ is greater or equal to 2 in the same rotating direction as that of the photoreceptor, the pile length is less than 3 mm, and the pile density is greater or equal to 200,000 piles/6.45 sq. cm, the toner is effectively dispersed so that the image with streaks generated by the slipped toner is not generated. The peripheral velocity refers to the velocity of the photoreceptor surface or the velocity of the charging member surface. The peripheral velocity ratio or the linear velocity ratio herein is represented by the peripheral velocity (mm/s) of the charging member surface divided by the peripheral velocity (mm/s) of the photoreceptor surface. Furthermore, the toner is uniformly charged by the charging brush so that a high image quality is achieved.

TABLE 4

| | | | PHERIPHERAL | | |
|---|---|---|---|---|---|
| | PILE | PILE | VELOCITY θ | | |
| MATERIAL | LENGTH | DENSITY | 1 | 2 | 3 |
| NYLON | 4 | 200,000 | UNREMOVED | UNREMOVED | NO |
| | | | STREAK | STREAK | |
| | 3 | 200,000 | UNREMOVED | NO | NO |
| | | | STREAK | | |
| | 2 | 200,000 | UNREMOVED | NO | NO |
| | | | STREAK | | |
| | 3 | 100,000 | UNREMOVED STREAK | UNEVEN | UNEVEN |
| | | | AND UNEVEN | CHARGING | CHARGING |
| | | | CHARGING | | |
| | 3 | 200,000 | UNREMOVED | NO | NO |
| | | | STREAK | | |
| | 3 | 300,000 | UNREMOVED | NO | NO |
| | | | STREAK | | |
| ACLYRIC | 4 | 200,000 | UNREMOVED | NO | NO |
| | | | STREAK | | |
| | 2 | 200,000 | UNREMOVED | NO | NO |
| | | | STREAK | | |
| | 3 | 6,000 | UNREMOVED STREAK | UNEVEN | UNEVEN |
| | | | AND UNEVEN | CHARGING | CHARGING |
| | | | CHARGING | | |

According to the experiment result shown in Table 4, the toner is effectively dispersed, and an image without streaks is formed by the unremoved toner. However, if the charging brush is strenuously in contact with the photoreceptor, the brush piles strenuously scrape the photoreceptor, causing the photoreceptor drum to have an irregular shape after a certain usage time. Consequently, the photoreceptor drum is unevenly polished. If the contact condition of the charging brush is reasonably adjusted, as will be discussed next, the photoreceptor is evenly polished, and an image quality may be achieved for a long period of usage of the photoreceptor.

An experiment was performed to confirm the uneven polishing of the photoreceptor. Table 5 illustrates the results of the experiment in which the toner having circularity of 0.99 and charging brushes made from nylon with a different pile length and contact depth are used to make 20,000 prints with A4 paper. Each charging brush has the pile density of 200,000 piles/6.45 sq. cm and the pile thickness of 2 decitex, and is rotated in a same direction as that of the photoreceptor at the peripheral velocity θ=2 relative to the photoreceptor. According to the experiment result in Table 5, when 0.5>ρ/L>0.06, where L is the pile length and ρ is the brush contact depth, the toner dispersing effect is maintained, and the uneven polishing of the photoreceptor does not occur so that the image quality is achieved during a long period of usage of the photoreceptor.

TABLE 5

| PILE | CONTACT | | UNREMOVED |
|---|---|---|---|
| LENGTH L | DEPTH ρ | ρ/L | STREAK |
| 3 | 0.1 | 0.03 | YES |
| 3 | 1.4 | 0.47 | NO |
| 3 | 1.6 | 0.53 | YES |
| 0.8 | 0.05 | 0.06 | NO |
| 0.8 | 0.4 | 0.50 | NO |
| 0.8 | 0.5 | 0.63 | YES |

In the above-described image forming apparatuses a process cartridge, which integrally supports the photoreceptor and at least one of the charging mechanism, the developing mechanism and the cleaning mechanism, and which is detachably configured with respect to the image forming apparatus main body, may be used. In one embodiment of the present invention, a plurality of the constituent elements such as the above-described photoreceptor, the charging mechanism, the developing mechanism, the cleaning mechanism and so forth may be integrated as a process cartridge. The process cartridge may detachably be configured with respect to the main body of the image forming apparatuses such as a copier, printer and so forth. Since the charging mechanism of one embodiment of the present invention is provided, and at least one of the image forming mechanisms is integrated as a process cartridge, a developing apparatus which maintains favorable image quality without streaks generated by the toner slipped through a cleaning blade may be realized. Furthermore, a process cartridge which allows easy maintenance and easy replacement of the image forming mechanism may be provided.

Embodiments of this invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. Embodiments of the present invention may also be implemented by the preparation of application specific integrated circuits or by interconnecting an appropriate network of conventional component circuits, as will be readily apparent to those skilled in the art.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods, when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An image forming apparatus using a toner, comprising:
a photoreceptor;
a cleaner having a blade-like shape and configured to remove contamination including residual toner from the photoreceptor; and
a charging mechanism including a charging brush which has a pile length not greater than 3 mm and a pile density of not smaller than 200,000 piles/6.45 sq. cm and the charging brush is configured to be rotated in a direction counter to a rotation direction of the photoreceptor while contacting the photoreceptor.

2. The image forming apparatus according to claim 1, wherein the charging brush of the charging mechanism satisfies a relationship of 0.4>ρ/L>0.05, where ρ is a contact depth of the charging brush relative to the photoreceptor and L is the pile length.

3. The image forming apparatus according to claim 1, further comprising:
a development mechanism configured to develop an image with the toner; and
a process cartridge configured to be attachable and detachable relative to the image forming apparatus and to integrally support the photoreceptor and at least one of the charging mechanism, the cleaning mechanism and the development mechanism.

4. The image forming apparatus according to claim 1, wherein the toner has particles with a diameter between 3 and 9 μm.

5. An image forming apparatus using a toner, comprising:
a photoreceptor;
a cleaner having a blade-like shape, the cleaner being configured to remove contamination including the toner from the photoreceptor; and
a charging mechanism including a charging brush which has a pile length of not greater than 3 mm and a pile density of not smaller than 200,000 piles/6.45 sq. cm and the charging brush is configured to be rotated in contact with the photoreceptor in a same direction as a rotation direction of the photoreceptor such that a peripheral velocity ratio of the charging brush to the photoreceptor is greater than or equal to 2.

6. The image forming apparatus according to claim 5, wherein the charging brush of the charging mechanism satisfies a relationship of 0.5>ρ/L>0.06, where ρ is a contact depth of the charging brush relative to the photoreceptor and L is the pile length.

7. The image forming apparatus according to claim 5, wherein the toner has particles with a diameter between 3 and 9 μm.

8. A process cartridge for use in an image forming apparatus using a toner, the process cartridge comprising:
a photoreceptor; and
a mechanism including
a development mechanism configured to develop an image formed on the photoreceptor with the toner,
a cleaning mechanism having a blade-like shape and configured to remove contamination including residual toner from the photoreceptor, and
a charging mechanism including a charging brush which has a pile length not greater than 3 mm and a pile density of not smaller than 200,000 piles/6.45 sq. cm and the charging brush is configured to be rotated in a direction counter to a rotation direction of the photoreceptor while contacting the photoreceptor.

9. The process cartridge according to claim 8, wherein the toner has particles with a diameter between 3 and 9 μm.
